(19) United States
(12) Patent Application Publication
(10) Pub. No.: US 2008/0247560 A1
(43) Pub. Date: Oct. 9, 2008

(54) AUDIO OUTPUT DEVICE

(76) Inventors: Akihiro Fukuda, Osaka (JP); Kouji Okamura, Hyogo (JP)

Correspondence Address: MCDERMOTT WILL & EMERY LLP, 600 13TH STREET, NW, WASHINGTON, DC, 20005-3096, US

(21) Appl. No.: 12/062,279

(22) Filed: Apr. 3, 2008

(30) Foreign Application Priority Data
Apr. 4, 2007 (JP) 2007-098158

(51) Int. Cl. G10K 11/16

(52) U.S. Cl. 381/71.6

(57) ABSTRACT

An audio collector collects an ambient sound near a sound-catching ear and converts the collected ambient sound into a collected-sound electrical signal. A noise canceller generates an offset sound for acoustically canceling the ambient sound based on a phase-inverted collected-sound electrical signal obtained when a phase of the collected-sound electrical signal is inverted and emits the generated offset sound near the sound-catching ear. An ambient sound monitor generates a monitor sound which is a phase inversion sound of the ambient sound based on the phase-inverted collected-sound electrical signal and emits the generated monitor sound near the sound-catching ear.

### BACKGROUND OF THE INVENTION

1. Field of the Invention

The present invention relates to an audio output device (audio device or the like) comprising a noise canceling function and an ambient sound monitoring function.

2. Description of the Related Art

In some conventional audio output devices such as a headphone, as an noise canceling function provided therein, an ambient sound leaking into the headphone from outside is collected by a microphone and converted into an electrical signal, and a signal phase of the electrical signal is inverted and a frequency characteristic of the electrical signal is adjusted in accordance with an acoustic variation generated while the ambient sound reaches the auditory meatus. Accordingly, the ambient sound is not easily heard, which makes it easy to catch a desired audible signal (musical sound and voice or the like). For example, the Japanese Patent Document (No. 2006-72114 of the Japanese Patent Applications Laid-Open) recites the noise canceling function for reducing the ambient sound by generating a speaker output sound having a phase reverse to that of the ambient sound.

In some audio output devices, as an ambient sound monitoring function provided therein, a desired frequency characteristic gain is increased so that only the ambient sound is amplified and any sound desired to be heard included in the ambient sound can be easily caught.

However, there are the following problems in the case where the noise canceling function and the ambient sound monitoring function are provided in one audio output device (headphone or the like). In order to realize the noise canceling function, it is necessary to collect the ambient sound at a position as close to an ear as possible, which makes it necessary to provide the microphone for collecting the ambient sound as closely to the speaker as possible. On the other hand, in the ambient sound monitoring function wherein the ambient sound collected by the microphone is amplified and then outputted through the speaker, however, the howling is more easily generated as a distance between the microphone and the speaker is shorter. Therefore, it is not advisable to bring the microphone very near to the speaker.

Thus, between the noise canceling function and the ambient sound monitoring function lies such a trade-off in the positional relationship between the speaker and the microphone, which makes it not possible to provide both the functions in such a manner that a satisfactory result can be obtained.

Further, in the noise canceling function, the frequency characteristic is generally adjusted in up to a lowest possible frequency band in order to remove the ambient sound in a lower frequency band. Therefore, if the ambient sound is amplified based on the same frequency characteristic as that of the noise canceling function while the ambient sound monitoring function is being operated, the ambient sound in the low frequency band (low-frequency noise) is also amplified. As a result, it becomes difficult to catch the ambient sound in a desired band, such as a human voice.

### SUMMARY OF THE INVENTION

Therefore, a main object of the present invention is to provide a noise canceling function and an ambient sound monitoring function together without any adverse influence on each other.

An audio output device according to the present invention comprises

an audio collector for collecting an ambient sound near a sound-catching ear and converting the collected ambient sound into a collected-sound electrical signal;

a noise canceller for generating an offset sound for acoustically canceling the ambient sound based on a phase-inverted collected-sound electrical signal obtained when a phase of the collected-sound electrical signal is inverted and emitting the generated offset sound near the sound-catching ear; and

an ambient sound monitor for generating a monitor sound which is a phase inversion sound of the ambient sound based on the phase-inverted collected-sound electrical signal and emitting the generated monitor sound near the sound-catching ear.

According to the present invention, wherein the phase of the monitor sound is inverted relative to the phase of the collected sound, the audio collector results in the negative feedback with respect to the monitor sound, which makes it difficult for the howling to be generated. Therefore, a sufficient volume level of the monitor sound can be secured even though the noise canceller and the ambient sound monitor (more specifically, audio emitter and audio collector provided therein as indispensable components) are provided adjacent to each other.

The audio output device preferably further comprises:

a phase inverter for generating the phase-inverted collected-sound electrical signal from the collected-sound electrical signal; and

an audio emitter for converting the various electrical signals into audio and emitting the audio near the sound-catching ear, wherein

the noise canceller generates an electrical signal for generating the offset sound based on the phase-inverted collected-sound electrical signal generated by the phase inverter and supplies the generated electrical signal to the audio emitter, and

the ambient sound monitor generates an electrical signal for generating the monitor sound based on the phase-inverted collected-sound electrical signal generated by the phase inverter and supplies the generated electrical signal to the audio emitter.

In the foregoing constitution, the noise canceller and the ambient sound monitor preferably share the phase inverter and the audio emitter. Accordingly, the number of the components to be provided can be reduced, which realizes the size reduction and the cost reduction of the device.

The noise canceller preferably adjusts a gain of the electrical signal for generating the offset sound to a level suitable for the offset sound to acoustically cancel the ambient sound, and

the ambient sound monitor preferably adjusts a gain of the electrical signal for generating the monitor sound to a level suitable for the ambient sound to be caught by the sound-catching ear.

Accordingly, the leak sound can be accurately offset, and the monitor sound thereby becomes more audible.

The audio output device according to the present invention preferably further comprises a selector for selecting one of the noise canceller and the ambient sound monitor as an effective function.

The audio output device according to the present invention preferably further comprises

an sound source for outputting an electrical signal for generating a sound desired to be heard which is converted into a sound desired to be heard by the audio emitter; and

a combiner for combining the electrical signal for generating the offset sound or the electrical signal for generating the monitor sound outputted by the noise canceller or the ambient sound monitor selected by the selector with the electrical signal for generating the sound desired to be heard and outputting a combined result to the audio emitter.

Accordingly, the effect of the present invention can be enjoyed while it is made possible to listen to the sound desired to be heard.

The noise canceller preferably adjusts the gain of the electrical signal for generating the offset sound so that the ambient sound can be effectively reduced by the offset sound.

The noise canceller preferably adjusts a frequency characteristic of the electrical signal for generating the offset sound so that the ambient sound can be effectively reduced by the offset sound. As a result, the leak sound can be more accurately offset.

The ambient sound monitor preferably adjusts a frequency characteristic of the electrical signal for generating the monitor sound so that a gain of the monitor sound is increased in a desired band and controlled in any band other than the desired band in a frequency characteristic of the monitor sound. As a result, it is made possible to listen to the monitor sound in a more favorable manner.

An example of the desired band is a human vocal range. Accordingly, sound in the human vocal range can be heard as the monitor sound, while the emission of the ambient sound in any band other than the desired band, for example, a low frequency band, can be blocked. The human vocal range is merely an example of the desired band, and the band in which sound is desired to be heard is not limited to this particular band. The audio output device according to the present invention preferably further comprises a barrier wall for acoustically separating a listening space where the sound-catching ear is present and an external space, the barrier wall being provided between the spaces, wherein the ambient sound is generated in the external space.

According to the audio output device of the present invention, the howling hardly occurs even though the audio collector and the audio emitter, which are the indispensable components of the noise canceller and the ambient sound monitor, are adjacently provided. Therefore, when the ambient sound monitor is operated, the volume of the sound thereby emitted can be increased to a sufficient level, and the audio output device can be downsized.

Further, the leak sound in the low frequency band can also be offset when the noise canceller is operated, while only the audio in the desired band, such as the human voice, can be amplified to be easily heard when the ambient sound monitor is operated. The present invention is particularly useful to a portable audio device or the like.

### BRIEF DESCRIPTION OF THE DRAWINGS

These and other objects as well as advantages of the invention will become clear by the following description of preferred embodiments of the invention and specified in the claims attached hereto. A number of benefits not recited in this specification will come to the attention of the skilled in the art upon the implementation of the present invention.

FIG. 1 is a circuit diagram of an audio output device according to a preferred embodiment of the present invention.

FIGS. 2A and 2B are frequency characteristic charts of an electrical signal for generating an offset sound and an electrical signal for generating a monitor sound according to the preferred embodiment.

FIGS. 3A and 3B are operation charts of a noise canceller and an ambient sound monitor according to the preferred embodiment.

FIG. 4 shows a basic constitution of the noise canceller.

FIG. 5 shows a basic constitution of the ambient sound monitor.

### DETAILED DESCRIPTION OF THE INVENTION

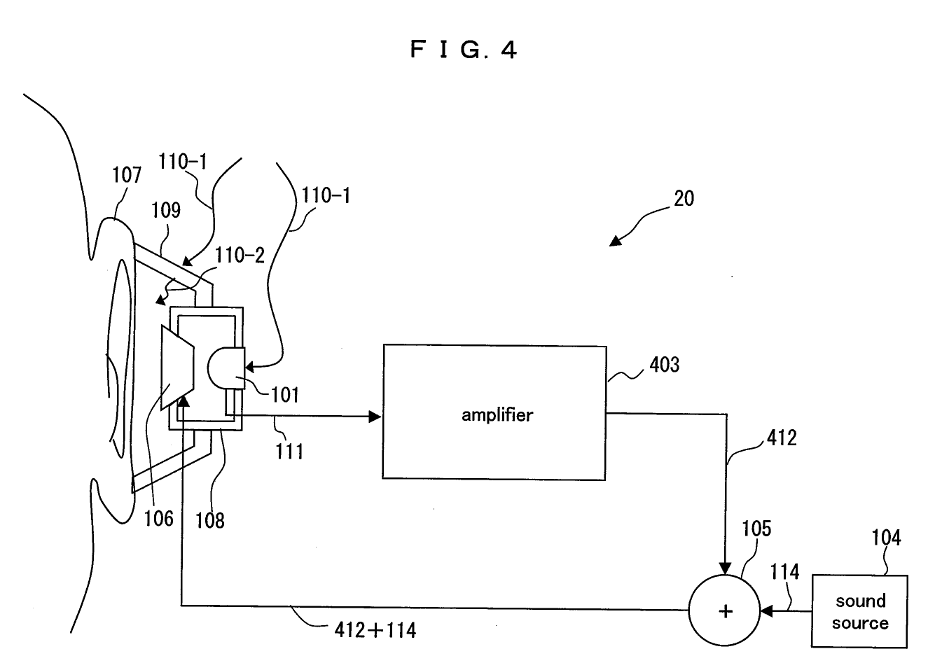

First, a basic constitution of an audio output device for realizing a noise canceling function, which is the basis of the present invention, is described referring to FIG. 4 before a preferred embodiment of the present invention is described. The basic constitution comprises a unit 108. The unit 108 comprises an ear cap 109 provided so as to cover a sound-catching ear 107 and serves to block an ambient sound entering the sound-catching ear 107 to a certain extent, a microphone 101 for collecting an ambient sound 110-1 around the ear cap 109 and converting the collected sound into a collected-sound electrical signal, and a speaker 106 for converting the collected-sound electrical signal into audio and emitting the audio near the sound-catching ear 107.

The ambient sound 110-1 is converted into a collected-sound electrical signal 111 by the microphone 101. The collected-sound electrical signal 111 is subjected to phase inverting processing, gain adjusting processing and frequency characteristic adjusting processing by an amplifier 403. The collected-sound electrical signal 111 is thereby converted into an electrical signal 412 for generating an offset sound. The electrical signal 412 for generating the offset sound is combined with an electrical signal 114 for generating a sound desired to be heard outputted from a sound source (from which a music signal, or the like, is outputted) 104 in a combiner 105. A combined signal 412+114 outputted from the combiner 105 is converted into audio in the speaker 106 and then outputted. The sound-catching ear 107 catches the outputted audio.

The ambient sound 110-1 is blocked by the ear cap 109, Therefore, a sound volume of a leak sound 110-2 (ambient sound 110-1 reaching the sound-catching ear 107 via the ear cap 109) is smaller by a certain degree than a sound volume of the ambient sound 110-1. Further, the electrical signal 412 for generating the offset signal, which is obtained when the collected-sound electrical signal 111 generated from the ambient sound 110-1 is phase-inverted, is converted into audio by the speaker 106 and then outputted. Therefore, the audio emitted from the speaker 106 includes an audio component based on the electrical signal 412 for generating the offset sound. The audio component becomes a sound having a phase reverse to that of the leak sound 110-2 and cancels the leak sound 110-2 to thereby reduce an audio level thereof. As a result, a sound desired to be heard emitted based on the electrical signal 114 for generating the sound desired to be heard in the speaker 106 is caught by the sound-catching ear 107.

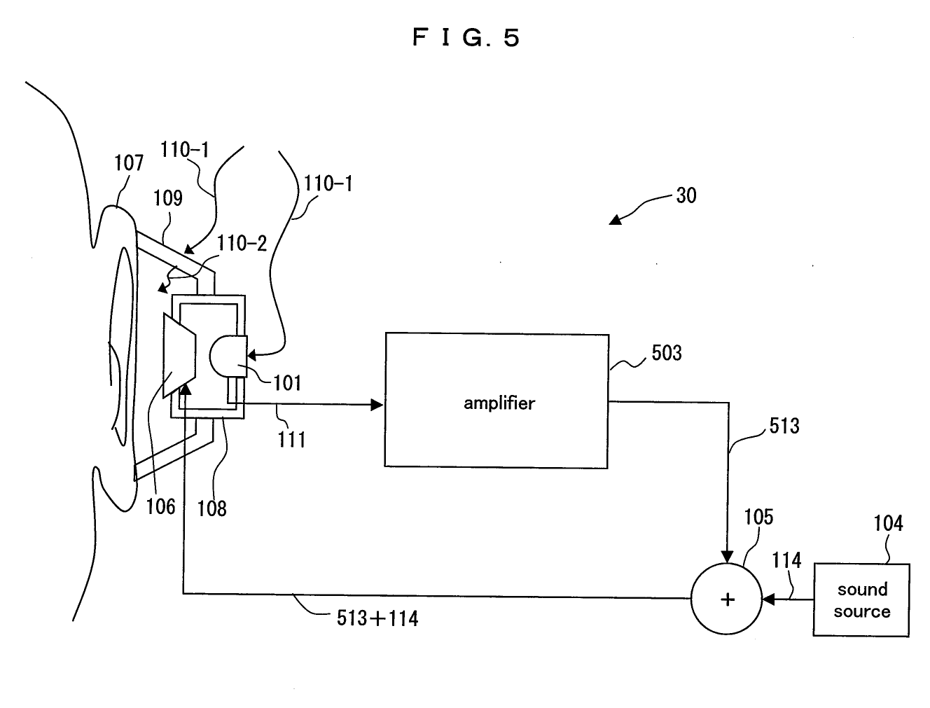

Next, a basic constitution of an audio output device for realizing an ambient sound monitoring function, which is the basis of the present invention, is described referring to FIG. 5. The same components as those shown in FIG. 4 are provided with the same reference symbols. The basic constitution comprises a unit 108, an amplifier 503, a combiner 105 and a sound source 104. The collected-sound electrical signal 111 generated from the ambient sound 110-1 by the microphone 101 is converted into an electrical signal 513 for generating the monitor sound in the amplifier 503. At the time, the phase of the collected-sound electrical signal 111 is not inverted though a gain in a desired frequency band is increased (which is a basic difference in comparison to the present invention). The electrical signal 114 for generating the sound desired to be heard outputted from the sound source 104 and the electrical signal 513 for generating the monitor sound are combined with each other in the combiner 105. A combined signal 513+114 generated by the combiner 105 is converted into audio by the speaker 106.

As a result, the ambient sound (ambient sound 110-1) is heard via the sound-catching ear 107 as a sound having a volume larger than that of the leak sound.

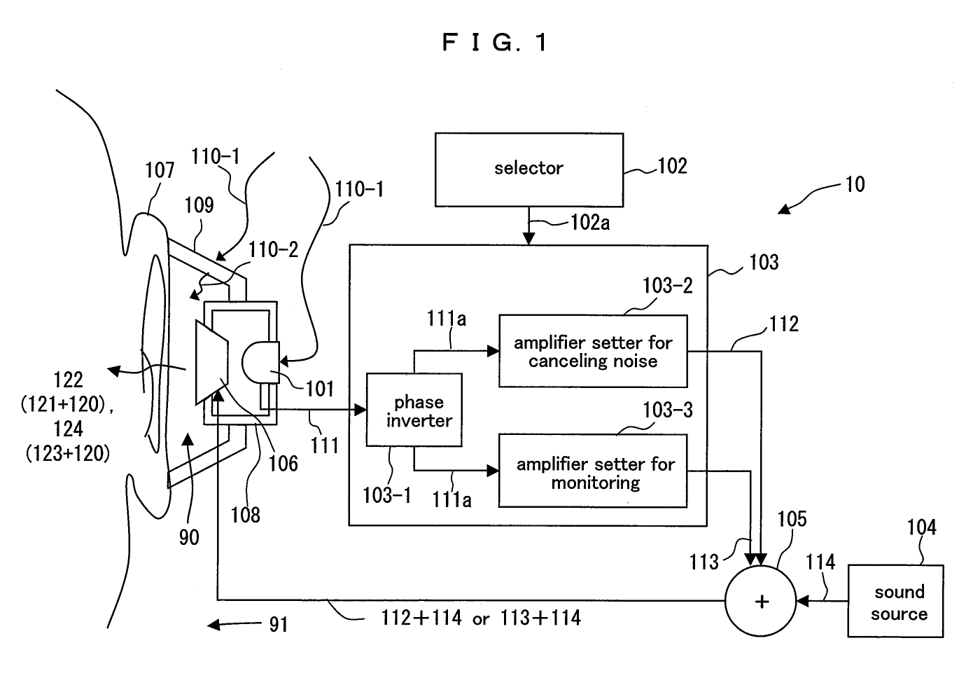

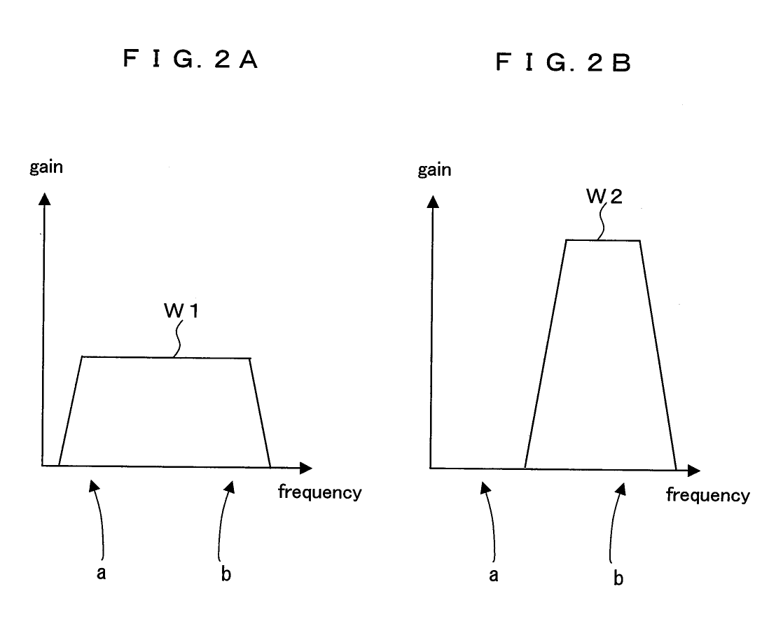

Hereinafter, a best mode for implementing an audio output device comprising a microphone according to the present invention is described in detail referring to FIGS. 1-3. FIG. 1 shows a circuit configuration of an audio output device according to the preferred embodiment. FIGS. 2A and 2B respectively show a frequency characteristic in a noise canceling function and a frequency characteristic in an ambient sound monitoring function in the audio output device according to the preferred embodiment.

An audio output device 10 comprises a unit 108, a selector 102, a phase inversion amplifier 103, a sound source 104, and a combiner 105. A reference numeral 107 shown in the drawing denotes a sound-catching ear of a listener.

The unit 108 comprises an ear cap 109 which is an example of a barrier wall for acoustically separating a listening space 90 which includes the sound-catching ear 107 and an external space 91, a microphone 101 which is an example of an audio collector, and a speaker 106 which is an example of an audio emitter. The ear cap 109 covers the sound-catching ear 107 so as to acoustically separate the listening space 90 and the external space 90 from each other; however, reduces a leak sound 110-2 leaking from the external space 91 into the listening space 90 using a certain frequency characteristic (In the present preferred embodiment, the leak sound 110-2 is substantively the ambient sound). The microphone 101 collects an ambient sound 110-1 generated in the external space 91 and converts the collected sound into a collected-sound electrical signal 111. The phase inversion amplifier 103 selectively generates one of an electrical signal 112 for generating an offset sound and an electrical signal 113 for generating a monitor sound based on the collected-sound electrical signal 111. The combiner 105 combines an electrical signal 114 for generating a sound desired to be heard outputted from the sound source 104 with the electrical signal 112 for generating the offset sound or the electrical signal 113 for generating the monitor sound outputted from the phase inversion amplifier 103 to thereby generate a first combined electrical signal 112+114 or a second combined signal 113+114, The speaker 106 converts the first or second combined signal 112+114 or 113+114 into audio and emitting the audio near the sound-catching ear 107. More specifically, when the first combined signal 112+114 is converted into the audio, the speaker 106 emits a first combined audio 122 in which a sound desired to be heard 120 (musical sound, voice or the like) superposed on the electrical signal 114 for generating the sound desired to be heard and an offset sound 121 superposed on the electrical signal 112 for generating the offset sound are combined with each other. On the other hand, when the second combined signal 113+114 is converted into the audio, the speaker 106 generates a second combined audio 124 in which the sound desired to be heard 120 and a monitor sound 123 superposed on the electrical signal 113 for generating the monitor sound are combined with each other.

The phase inversion amplifier 103 comprises a phase inverter 103-1, an amplifier setter 103-2 for canceling a noise, and a monitoring amplifier setter 103-3. The phase inverter 103-1 inverts a phase of the collected-sound electrical signal 111 outputted from the microphone 101 to thereby generate a phase-inverted collected-signal electrical signal 111a. The amplifier setter 103-2 for canceling the noise adjusts a gain and a frequency characteristic of the phase-inverted collected-signal electrical signal 111a outputted from the phase inverter 103-1 to levels suitable for canceling the noise to thereby generate the electrical signal 112 for generating the offset sound. The monitoring amplifier setter 103-3 adjusts a gain and a frequency characteristic of the phase-inverted collected-signal electrical signal 111a outputted from the phase inverter 103-1 to levels suitable for monitoring the ambient sound to thereby generate the electrical signal 113 for generating the monitor sound. The phase inverter 103-1 and the amplifier setter 103-2 for canceling the noise may be integrally provided. In a similar manner, the phase inverter 103-1 and the monitoring amplifier setter 103-3 may be integrally provided.

The selector 102 controls the operations of the amplifier setter 103-2 for canceling the noise and the monitoring amplifier setter 103-3. More specifically, control is made to switch the operations of the two setters 103-2 and 103-3. The sound source 104 outputs the electrical signal 114 for generating the sound desired to be heard such as a music signal.

The offset sound 121 is an audio which acoustically cancels the leak sound 110-2 in the listening space 90, and a phase thereof is set to be reverse to that of the leak sound 110-2 so that the leak sound 110-2 is cancelled. Further, a sound volume of the offset sound 121 is set to such a sound volume that can effectively reduce the leak sound 110-2 (sound pressure level). The monitor sound 123 is an audio which arbitrarily collects the ambient sound 110-1 and emits the collected sound into the listening space 90, and a sound volume thereof (sound pressure level) is set to be larger than that of the leak sound 110-2 in order to be audible via the sound-catching ear 107. In the present preferred embodiment, the monitor sound 123 has a phase reverse to that of the ambient sound 110-1.

In the present preferred embodiment, the phase inverter 103-1, amplifier setter 103-2 for canceling the noise and speaker 106 constitute the noise canceller, while the phase inverter 103-1, amplifier setter 103-3 for monitoring the ambient sound and speaker 106 constitute the ambient sound monitor. Thus, the noise canceller and the ambient sound monitor according to the present preferred embodiment share the phase inverter 103-1 and the speaker 106.

Below is described the operation of the audio output device according to the present preferred embodiment. A user sets the selector 102 so as to switch the noise canceling function and the ambient sound monitoring function arbitrarily. The selector 102 selects one of the amplifier setter 103-2 and the amplifier setter 103-3 as an effective function in the phase inversion amplifier 103 based on the user's instruction.

When the microphone 101 collects the ambient sound 110-1 and converts the collected sound into the collected-sound electrical signal 111 after the foregoing preparations are made, the phase inverter 103-1 inverts the phase of the collected-sound electrical signal 111 to thereby generate the phase-inverted collected-sound electrical signal 111a, There are two different types of post processing for the phase-inverted collected-sound electrical signal 111a thus generated, as follows.

Processing in the State where the Selector 102 Selects the Noise Canceling Function

In this state, the function of the amplifier setter 103-2 is effective, and the electrical signal 112 for generating the offset sound is generated from the phase-inverted collected-sound electrical signal 111a. At the time, the frequency characteristic and the gain of the electrical signal 112 for generating the offset sound are adjusted to the levels suitable for the offset sound 121 to acoustically cancel the leak sound 110-2 in the listening space 90. More specifically, the electrical signal 112 for generating the offset sound is adjusted as follows:
The phase is adjusted to be reverse to that of the collected sound electrical signal 111. This adjustment is made by the phase inverter 103-1.
The gain of the offset sound 121 is adjusted so that such a sound volume (sound pressure level) that can effectively reduce the leak sound 110-2 is obtained by the offset sound 121 This adjustment is made by the amplifier setter 103-2 for canceling the noise.
A frequency characteristic of the offset sound 121 is set so that the leak sound 110-2 can be effectively reduced by the offset sound 121 in a frequency band having a width equal to that of a frequency band of the leak sound 110-2. This adjustment is made by the amplifier setter 103-2 for canceling the noise. The frequency characteristic so as to effectively reduce the leak sound 110-2 using the offset sound 121 herein means such a frequency characteristic that the leak sound 110-2 caught by the sound-catching ear 107 after being subjected to the acoustic variation generated by the time when the offset sound 121 reaches the auditory meatus of the sound-catching ear 107 can be reduced by the offset sound 121 caught by the sound-catching ear 107 after being subjected to the acoustic variation generated by the time when the offset sound 121 reaches the auditory meatus of the sound-catching ear 107 in the same manner.

Processing in the State where the Selector 102 Selects the Ambient Sound Monitoring Function

In this state, the function of the amplifier setter 103-3 is effective, and the electrical signal 113 for generating the monitor sound is generated from the phase-inverted collected-sound electrical signal 111. At the time, the frequency characteristic and the gain of the electrical signal 113 for generating the monitor sound are adjusted to the levels suitable for only a desired band (renge of voice and so on) to be amplified by the amplifier setter 103-3. More specifically, the electrical signal 113 for generating the monitor sound is adjusted as follows.
The phase is adjusted to be reverse to that of the collected sound electrical signal 111. This adjustment is made by the phase inverter 103-1.
The gain is adjusted in the frequency characteristic thereof so that the monitor sound 123 emitted in the listening space based on the electrical signal 113 for generating the monitor sound can becomes clearly audible via the sound-catching ear 107. This adjustment is made by the amplifier setter 103-3 for monitoring the ambient sound.
The gain is adjusted in the frequency characteristic thereof so that the gain is increased in the desired band (such as a band for human voice) and controlled in any band other than the desired band. This adjustment is made by the phase inverter 103-3 for monitoring the ambient sound.

The electrical signal 112 for generating the offset sound or the electrical signal 113 for generating the monitor sound thus adjusted is supplied from the phase inversion amplifier 103 to the combiner 105. The combiner 105 combines the electrical signal 112 or 113 with the electrical signal 114 for generating the sound desired to be heard outputted from the sound source 104, and outputs the first combined signal 112+114 or the second combined signal 113+114. The speaker 106 converts the first combined signal 112+114 or the second combined signal 113+114 into the first combined audio 122 or the second combined audio 124 to thereby produce the audio.

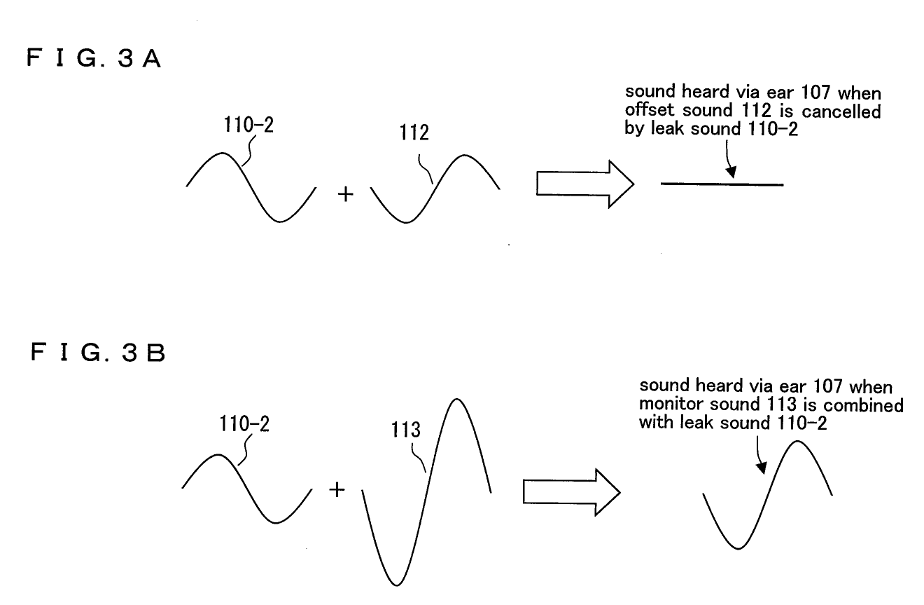

In the case where the noise canceling function is set by the selector 102 at the time, the first combined signal 112+114 is converted into the first combined audio 122 by the speaker 106 and then outputted. The first combined audio 122 thus emitted includes the following audio component. The first combined audio 122 includes the offset sound 121 obtained when the electrical signal 112 for generating the offset sound, as to which the collected-sound electrical signal 111 outputted from the microphone 101 is phase-inverted and the frequency characteristic thereof is adjusted to be suitable for canceling the noise, is converted into the audio. Therefore, when the first combined signal 112+114 is converted into the first combined audio 122 by the speaker 106 and then emitted, as shown in FIG. 3A, the leak sound 110-2 is cancelled by the offset sound 121 included in the first combined audio 122, and the sound desired to be heard (musical sound, voice or the like) 120 superposed on the electrical signal 114 for generating the sound desired to be heard is clearly heard via the sound-catching ear 107.

On the other hand, in the case where the ambient sound monitoring function is set by the selector 102 at the time, the second combined signal 113+114 is converted into the second combined audio 124 by the speaker 106 and then outputted. The second combined audio 124 thus emitted includes the monitor sound 123. The monitor sound 123 is the audio obtained when the electrical signal 113 for generating the monitor sound, as to which the collected-sound electrical signal 111 outputted from the microphone 101 is phase-inverted and the frequency characteristic thereof is adjusted to be suitable for monitoring the ambient sound, is converted into the audio. Therefore, when the second combined audio 124 is emitted via the speaker 106, as shown in FIG. 3B, the amplified ambient sound 110-1 is monitored by the monitor sound 123 included in the second combined audio 124. As a result, the ambient sound 110-1 in the band desired to be heard such as that for the human voice in the periphery can be easily caught. In the state where the ambient sound monitoring function is set by the selector 102, the combiner 105 may slightly reduce the signal level of the electrical signal 114 for generating the sound desired to be heard and then combine the electrical signal 114 for generating the sound desired to be heard with the electrical signal 113 for generating the monitor sound. Accordingly, the monitor sound 123 can be more favorably caught by the sound-catching ear 107.

Some microphones convert the collected audio signal into the electrical signal whose phase is reverse to that of the collected audio signal and output it. In the case where any of the microphones of this type is used as the microphone 101, the phase inversion amplifier 103 is changed into a phase non-inversion amplifier comprising a phase non-inversion unit so that an effect equal to that of the preferred embodiment 1 can be obtained.

The present invention of which the preferred embodiment is described has the following first and second characteristics.

First Characteristic

In the present invention, the phase of the collected-sound electrical signal 111 outputted from the microphone 101 is always inverted by the phase inversion amplifier 103 irrespective of whether the noise canceling function or the ambient sound monitoring function is effective.

In the conventional method, the noise canceling function and the ambient sound monitoring function are related to each other in the trade-off manner in the positional relationship between the microphone 101 and the speaker 106 as described earlier. Therefore, it is not possible to provide the microphone 101 and the speaker 106 as closely to each other as possible, which is demanded by the nose canceling function.

In contrast, according to the present invention, the collected-sound electrical signal 111 is phase-inverted and then amplified even in the case where the ambient sound monitoring function is set. Accordingly, the output of the speaker 106 (second combined audio 124) and the output of the microphone 101 (collected-sound electrical signal 111) result in the negative feedback, which makes it difficult for the howling to be generated. Based on the reason, the microphone 101 and the speaker 106 can be provided more adjacently to each other, which improves the noise canceling function. Further, the unit 108 can be downsized because the microphone 101 and the speaker 106 can be provided at a shorter distance therebetween.

Second Characteristic

In the present invention, as shown in FIG. 2A, the gain of the phase inversion amplifier 103 is adjusted so that the offset sound 121 adjusted to the sound level capable of reducing the leak sound 110-2 is outputted from the speaker 106 in the case where the noise canceling function is set. Further, the frequency characteristic is adjusted so that the gain band is extended to a low frequency band “a” in order to offset the ambient sound 110-1 in the low frequency band. In the case where the ambient sound monitoring function is set, as shown in FIG. 2B, the frequency characteristic is adjusted in such a manner that the gain of a desired band “b” is selectively increased so that the audio in the desired band “b” (vocal range or the like) desired to be audible in the ambient sound 110-1 can be selectively heard, while the gain in any other band (low frequency band “a” or the like) is not increased and adjusted to be as close to the zero level as possible.

According to the second characteristic, the leak sound 110-2 in the low frequency “a”, which is an offence to the ear, can be cancelled in the case where the noise canceling function is set, while the audio in the desired band (vocal range “b” or the like) can be easily heard without any increase of the sound volume of the leak sound 110-2 in any other band (low frequency band “a” or the like) which is unnecessary and not desired to be heard in the case where the ambient sound monitoring function is set.

In the preferred embodiment described so far, the ear cap 109 as the barrier wall is provided so that the listening space 90 and the external space 91 are acoustically separated from each other. However, the present invention is not limitedly applicable to such a constitution. As far as the ear cap 109 has a structure where the speaker 106 can be opposingly placed relative to the sound-catching ear 107, it is not necessary for the ear cap 109 to comprise the function for acoustically separating the listening space 90 and the external space 91 from each other. The constitution in this case is similar to that of FIG. 1. Thus, the present invention can be implemented to an audio output device in which the listening space 90 and the external space 91 are not acoustically separated from each other.

While there has been described what is at present considered to be preferred embodiments of this invention, it will be understood that various modifications may be made therein, and it is intended to cover in the appended claims all such modifications as fall within the true spirit and scope of this invention.

What is claimed is:

1. An audio output device comprising:
an audio collector for collecting an ambient sound near a sound-catching ear and converting the collected ambient sound into a collected-sound electrical signal;
a noise canceller for generating an offset sound for acoustically canceling the ambient sound based on a phase-inverted collected-sound electrical signal obtained when a phase of the collected-sound electrical signal is inverted and emitting the generated offset sound near the sound-catching ear; and
an ambient sound monitor for generating a monitor sound which is a phase inversion sound of the ambient sound based on the phase-inverted collected-sound electrical signal and emitting the generated monitor sound near the sound-catching ear.

2. The audio output device as claimed in claim 1, further comprising:
a phase inverter for generating the phase-inverted collected-sound electrical signal from the collected-sound electrical signal; and
an audio emitter for converting the various electrical signals into audio and emitting the audio near the sound-catching ear, wherein
the noise canceller generates an electrical signal for generating the offset sound based on the phase-inverted collected-sound electrical signal generated by the phase inverter and supplies the generated electrical signal to the audio emitter, and
the ambient sound monitor generates an electrical signal for generating the monitor sound based on the phase-inverted collected-sound electrical signal generated by the phase inverter and supplies the generated electrical signal to the audio emitter.

3. The audio output device as claimed in claim 2, wherein
the noise canceller and the ambient sound monitor share the phase inverter and the audio emitter.

4. The audio output device as claimed in claim 1, further comprising a selector for selecting one of the noise canceller and the ambient sound monitor as an effective function.

5. The audio output device as claimed in claim 4, further comprising:
an sound source for outputting an electrical signal for generating a sound desired to be heard which is converted into a sound desired to be heard by the audio emitter; and
a combiner for combining the electrical signal for generating the offset sound or the electrical signal for generating the monitor sound outputted by the noise canceller or the ambient sound monitor selected by the selector with the electrical signal for generating the sound desired to be heard and outputting a combined result to the audio emitter.

6. The audio output device as claimed in claim 2, wherein
the noise canceller adjusts a gain of the electrical signal for generating the offset sound to a level suitable for the offset sound to acoustically cancel the leak sound in the listening space, and
the ambient sound monitor adjusts a gain of the electrical signal for generating the monitor sound to a level suitable for the ambient sound to be caught by the sound-catching ear.

7. The audio output device as claimed in claim 6, wherein
the noise canceller adjusts a gain of the electrical signal for generating the offset sound so that the ambient sound can be effectively reduced by the offset sound.

8. The audio output device as claimed in claim 6, wherein
the noise canceller adjusts a frequency characteristic of the electrical signal for generating the offset sound so that the ambient sound can be effectively reduced by the offset sound.

9. The audio output device as claimed in claim 6, wherein
the ambient sound monitor adjusts a frequency characteristic of the electrical signal for generating the monitor sound so that a gain of the monitor sound is increased in a desired band and controlled in any band other than the desired band in a frequency characteristic of the monitor sound.

10. The audio output device as claimed in claim 9, wherein
the desired band is a human vocal range.

11. The audio output device as claimed in claim 1, further comprising a barrier wall for acoustically separating a listening space and an external space, the barrier wall being provided between the spaces, wherein
the ambient sound is generated in the external space.
